(19) United States
(12) Patent Application Publication
(10) Pub. No.: US 2015/0240788 A1
(43) Pub. Date: Aug. 27, 2015

(54) METHOD FOR DETECTING DAMAGE OF WIND TURBINE BLADE AND WIND TURBINE

(71) Applicant: MITSUBISHI HEAVY INDUSTRIES, LTD., Tokyo (JP)

(72) Inventors: Hiroyuki KAYAMA, Tokyo (JP); Takao KUROIWA, Tokyo (JP); Keisuke OTA, Tokyo (JP); Yoshiyuki HAYASHI, Tokyo (JP)

(21) Appl. No.: 14/499,339

(22) Filed: Sep. 29, 2014

(30) Foreign Application Priority Data
Feb. 27, 2014 (JP) 2014-037607

(51) Int. Cl. F03D 11/00; G01N 19/08

(52) U.S. Cl. CPC F03D 11/0091; G01N 19/08

(57) ABSTRACT

A method for detecting a damage of a wind turbine blade of a wind turbine rotor including a plurality of wind turbine blades includes: a strain data acquiring step of acquiring strain data representing strain of each of the plurality of wind turbine blades; a difference calculation step of calculating a difference between the strain data of a detection target wind turbine blade which is one of the wind turbine blades and a reference value reflecting the strain data of at least one comparison target wind turbine blade of other wind turbine blades; and a detection step of detecting the damage of the detection target wind turbine blade based on a trend of the difference calculated in the difference calculation step.

### TECHNICAL FIELD

The present disclosure relates to a method for detecting a damage of a wind turbine blade and a wind turbine.

### BACKGROUND

As a method for detecting a damage of a wind turbine blade, a method using a strain measured by a strain sensor has been known.

For instance, Patent Document 1 discloses a method for detecting the damage of the wind turbine blade in which whether or not the wind turbine blade is damaged is determined based on the result of a measurement of a torsional torque around a longitudinal axis by the strain sensor.

In this method, the torsional torque around the longitudinal axis is measured in order to acquire a detection torque signal. Then the value based on the acquired detection torque signal is compared with a reference value obtained from a measurement value having a predetermined relation with a torsion torque around a longitudinal axis of the wind turbine blade under normal operation conditions. Further, in a case where a difference between the value based on the detection torque signal and the reference value is larger than a predetermined value, it is determined that the damage has occurred in the wind turbine blade.

### CITATION LIST

### Patent Literature

### Patent Document 1: WO2012/007004A

### SUMMARY

The value of the strain in the wind turbine blade gradually changes due to the occurrence or the progress of the damage (e.g., crack) which results in the breakage of the wind turbine blade until the state of the wind turbine blade changes from a sound state to the broken state. Therefore, in the method for detecting the damage of the wind turbine blade described in Patent Document 1, the damage of the wind turbine blade is detected by monitoring the change of data representing the strain of the wind turbine blade. Thus, the damage of the wind turbine blade can be detected more accurately than a conventional method in which the damage is evaluated by the visual inspection.

However, the strain in the wind turbine blade changes not only due to the occurrence or the progress of the damage which results in the breakage, but also due to the operation conditions of the wind turbine such as the change in wind speed or the like.

In this respect, Patent Document 1 does not disclose a method for detecting the damage of the wind turbine blade in consideration of the strain change due to the operation condition.

It is an object of at least one embodiment of the present invention to provide a method for detecting the damage of the wind turbine blade by using the strain data representing the strain of the wind turbine blade, whereby the influence due to the operation conditions such as the change in wind speed can be eliminated.

According to at least one embodiment of the present invention, a method for detecting a damage of a wind turbine blade of a wind turbine rotor including a plurality of wind turbine blades comprises:

a strain data acquiring step of acquiring strain data representing strain of each of the plurality of wind turbine blades;

a difference calculation step of calculating a difference between the strain data of a detection target wind turbine blade which is one of the wind turbine blades and a reference value reflecting the strain data of at least one comparison target wind turbine blade of other wind turbine blades; and

a detection step of detecting the damage of the detection target wind turbine blade based on a trend of the difference calculated in the difference calculation step.

According to the above method for detecting the damage of the wind turbine blade, the damage of the wind turbine blade is detected by using the difference between the strain data of the detection target wind turbine blade which is one of the wind turbine blades and the reference value reflecting the strain data of at least one comparison target wind turbine blade of other wind turbine blades. Thus, it is possible to eliminate the influence on the damage detection due to an operation state such as a change in wind speed or the like. Consequently, an abnormality due to the damage of the wind turbine blade can be accurately detected.

Further, since the strain data required for the method for detecting the damage of the wind turbine blade can be acquired even during an operation of the wind turbine, there is no need to stop the operation of the wind turbine to detect the damage of the wind turbine blade. Therefore, it is possible to detect the damage of the wind turbine blade without causing reduction of operation rates of the wind turbine.

According to some embodiments, in the detection step, when a value of the difference or a change rate of the difference exceeds a threshold value, the damage of the detection target wind turbine blade is detected.

As a result of intensive studies made by present inventors, it has been clear that the value of the difference or the change rate of the difference between the strain data of the detection target wind turbine blade and the reference value reflecting the strain data of the comparison target wind turbine blade rapidly increases immediately before the breakage of the wind turbine blade. Therefore, it is possible to judge whether the damage has occurred in the detection target wind turbine blade or not, according to whether these parameters exceed thresholds.

According to some embodiments, the wind turbine rotor includes at least three wind turbine blades, the difference of each of the wind turbine blades is calculated by repeating the difference calculation step for each of the wind turbine blades as the detection target wind turbine blade, and in the detection step, a damaged wind turbine blade is identified based on the difference as to each of the wind turbine blades.

In this case, when the damage occurs in any of the wind turbine blades, the value of the difference or the change rate of the difference is affected by whether or not the damaged wind turbine blade is the detection target wind turbine blade. Therefore, according to the above embodiments, the damaged wind turbine blade can be identified based on the value of the difference or the change rate of the difference as to each of the wind turbine blades which is repeatedly calculated by regarding each of wind turbine blades as the detection target wind turbine blade.

According to an embodiment, the at least one comparison target wind turbine blade is all of the other wind turbine blades except the detection target wind turbine blade.

In this case, when at least one of the wind turbine blades is damaged, the value of the difference or the change rate of the difference is affected to some extent, whichever wind turbine blade is the detection target wind turbine blade. However, the influence on the value of the difference or the change rate of the difference caused by the damage occurrence of any of the wind turbine blades changes depending on whether the damaged wind turbine blade is the detection target wind turbine blade or the comparison target wind turbine blade. Therefore, as mentioned above, the damaged wind turbine blade can be identified based on the value of the difference or the change rate of the difference obtained by regarding each of the wind turbine blades as the detection target wind turbine blade.

According to another embodiment, the wind turbine rotor include n wind turbine blades, n being an integer of 3 or more, when the detection target wind turbine blade is i-th wind turbine blade, the differences as to the wind turbine blades from 1st to n-th are calculated by repeating the difference calculation step for each of (n−1) wind turbine blades except i-th wind turbine blade as the comparison target wind turbine blade, i being an integer of not less than 1 and not greater than n, and, in the detection step, a damaged wind turbine blade is identified based on the difference as to each of the wind turbine blades.

In this case, when the damage occurs in any of the wind turbine blades, the influence on the value of the difference or the change rate of the difference caused by the damage occurrence of any of the wind turbine blades changes depending on whether the damaged wind turbine blade is the detection target wind turbine blade or the comparison target wind turbine blade. Therefore, as mentioned above, the damaged wind turbine blade can be identified based on the value of the difference or the change rate of the difference obtained by regarding each of the wind turbine blades as the detection target wind turbine blade.

According to some embodiments, a time mean calculation step of calculating a mean value of the strain data acquired in the strain data acquiring step for a longer period than a rotation period of the wind turbine rotor, and, in the detection step, the damage of the detection target wind turbine blade is detected based on the mean value calculated in the time mean calculation step.

When an azimuth angle of the wind turbine blade changes with a rotation of the wind turbine rotor, an altitude of the wind turbine blade is also changed. Furthermore, wind speed is generally higher as the altitude is higher. Thus, during an operation of the wind turbine, a load acting on the wind turbine blade changes periodically depending on wind speed, and thus, the strain generated in the wind turbine blade also changes periodically.

According to the embodiment, the damage of the detection target wind turbine blade is detected based on the mean value of the strain data acquired for the longer period than a rotation period of the wind turbine rotor. Thus, it becomes possible to exclude influences of the periodic change of the strain of the wind turbine blade to evaluate the damage, whereby the damage of the wind turbine blade can be more accurately detected.

According to some embodiments, in the detection step, the damage of the detection target wind turbine blade is detected by using only at least part of the strain data acquired in the strain acquiring step, the at least part of the strain data being acquired when wind speed is within a specified wind speed range.

Since the load acting on the wind turbine blade depends on wind speed, the strain data acquired in the strain data acquiring step varies with wind speed at a time when the strain data is acquired. According to the embodiment, the damage of the detection target wind turbine blade is detected by using only at least part of the acquired strain data, the at least part of the strain data being acquired when wind speed is within a specified wind speed range. As a result, the influence caused by variance of the strain data due to a change in the wind speed can be reduced, whereby the damage of the wind turbine blade can be more accurately detected.

According to at least one embodiment of the present invention, a method for detecting a damage of a wind turbine blade of a wind turbine rotor including at least one wind turbine blade includes:

a strain data acquiring step of acquiring strain data representing a strain of each of the at least one wind turbine blade by using a strain sensor provided on a blade root of each of the at least one wind turbine blade;

a coefficient calculation step of calculating a coefficient representing a relationship between the strain data acquired in the strain data acquiring step and a blade root moment acting on the blade root of the wind turbine blade; and

a detection step of detecting the damage of the wind turbine blade when a trend of the coefficient calculated in the coefficient calculation step deviates from a specified range.

The strain of the blade root of the wind turbine blade has a prescribed relationship with a blade root moment acting on the blade root, and there exists a coefficient specifying a relationship between the strain data and the blade root moment.

Moreover, the weight of the wind turbine blade is constant regardless of the change in the strain (for example, the change in the strain caused by the generation of cracks or the like), and thus the blade root moment acting on the blade root is also constant regardless of the influence of a value of the strain.

When a wind turbine blade in a sound state is compared with the wind turbine blade subject to the damage (for example, cracks or the like), the strain of the damaged wind turbine blade changes along with the progression of the damage unlike the case of the sound state. Given that the blade root moment is constant regardless of the change in the value of the strain, in the damaged wind turbine blade, the coefficient is considered to change depending on the change in the value of the strain.

Therefore, according to the embodiment, the damage of the wind turbine blade can be detected based on the trend of the coefficient representing the relationship between the strain data acquired by the strain sensor and the blade root moment acting on the blade root of the wind turbine blade.

According to some embodiments, in the strain data acquiring step, the strain data is acquired for both of a suction side and a pressure side of each wind turbine blade by using a pair of strain sensors provided for each of the blade roots on the suction side and the pressure side of each of the blade roots, and, in the detection step, the damage of the wind turbine blade is detected based on the difference between the strain data of the suction side and the strain data of the pressure side acquired for each wind turbine blade.

The change in the strain of the wind turbine blade tends to appear remarkably in a flap direction than in an edge direction. Further, the edge direction of the wind turbine blade is a chord direction connecting a leading edge and a trailing edge in a section orthogonal to a longitudinal direction of the wind turbine blade, and the flap direction is a direction orthogonal to the chord direction in the same section.

According to the embodiment, the damage of the wind turbine blade can be determined easily in the detection of the damage of the wind turbine blade because the damage of the wind turbine blade is detected based on the difference between the strain data of a suction side and the strain data of a pressure side of the wind turbine blade, namely the strain associated with the flap direction.

According to at least one embodiment of the present invention, a wind turbine includes;

a wind turbine rotor including wind turbine blades;

a strain sensor for detecting strain of each of the wind turbine blades; and

a damage detection part for detecting a damage of the wind turbine blades,

and the damage detection part is configured to calculate a difference between the strain data of a detection target wind turbine blade which is one of the wind turbine blades and a reference value reflecting the strain data of at least one comparison target wind turbine blade of other wind turbine blades so as to detect the damage of the wind turbine blade based on a trend of the difference.

According to the above wind turbine, the damage of the wind turbine blade is detected by using the difference between the strain data of the detection target wind turbine blade which is one of the wind turbine blades and the reference value reflecting the strain data of at least one comparison target wind turbine blade of other wind turbine blades. Thus, it is possible to eliminate the influence on the damage detection due to an operation condition such as a change in wind speed or the like. Consequently, an abnormality due to the damage of the wind turbine blade can be accurately detected.

Further, According to the above wind turbine, since the strain data required for the method for detecting the damage of the wind turbine blade can be acquired even during an operation of the wind turbine, there is no need to stop the operation of the wind turbine to detect the damage of the wind turbine blade. Therefore, it is possible to detect the damage of the wind turbine blade without causing reduction of operation rates of the wind turbine.

According to at least one embodiment of the present invention, in the damage detection of the wind turbine blade using the strain data representing the strain of the wind turbine blade, it is possible to eliminate the influence on a damage detection due to an operation condition such as a change in wind speed or the like.

### BRIEF DESCRIPTION OF DRAWINGS

FIG. 1 is a schematic diagram of a general configuration of a wind turbine according to one embodiment.

FIG. 2 is a sectional view orthogonal to the longitudinal direction of the wind turbine in the blade root part of the wind turbine blade shown in FIG. 1.

FIG. 3A is a graph showing an example of the trend of the difference of the strain data in the flap direction of the wind turbine blade shown in FIG. 1.

FIG. 3B is a graph showing an example of the trend of the difference of the strain data in the edge direction of the wind turbine blade shown in FIG. 1.

FIG. 4A is a graph showing a short term trend of the change in the difference of the strain data for a term T shown in FIG. 3A.

FIG. 4B is a graph showing a short term trend of the change in the difference of the strain data for a term T shown in FIG. 3B.

FIG. 5A is a graph showing a temporal change of the difference of the acquired strain data at the wind turbine blade of the wind turbine shown in FIG. 1.

FIG. 5B is a graph obtained by plotting the difference of the strain data shown in FIG. 5A relative to wind speed horizontal axis.

FIG. 6 is a graph showing an example of the relation between the strain data and the blade root moment of the wind turbine blade shown in FIG. 1.

FIG. 7A is a graph showing an example of the trend of a flap direction strain ε_{F} of the wind turbine blade.

FIG. 7B is a graph showing an example of the change of the coefficient where the flap direction strain ε_{F} of the wind turbine blade is changed as shown in FIG. 7A.

### DETAILED DESCRIPTION

Embodiments of the present invention will now be described in detail with reference to the accompanying drawings. It is intended, however, that dimensions, materials, shapes, relative positions and the like of components described in the embodiments shall be interpreted as illustrative only and not limitative of the scope of the present invention.

First of all, a configuration of the wind turbine provided with the wind turbine blade as an object of the damage detection in the present invention will be described.

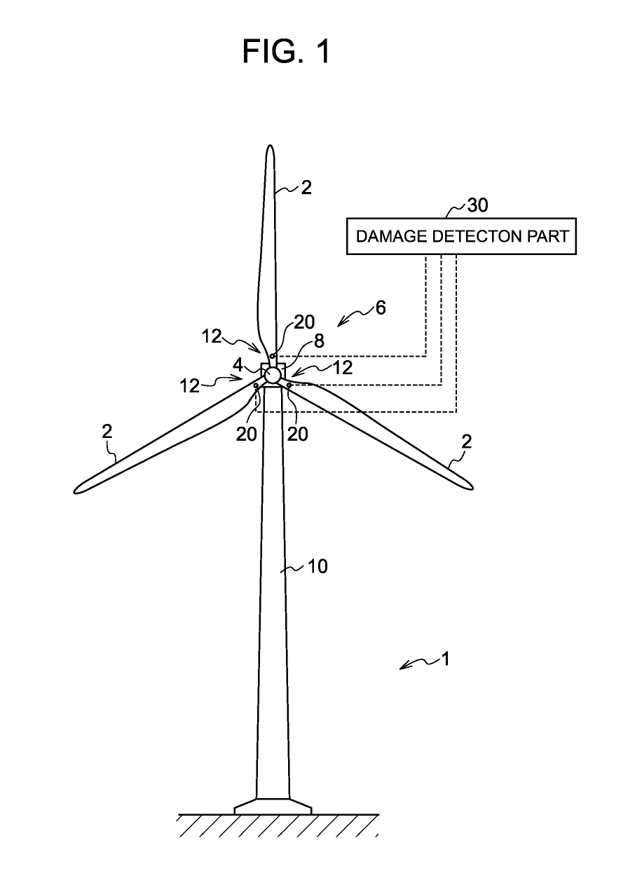

FIG. 1 is a schematic diagram of a general configuration of the wind turbine 1 according to one embodiment of the present invention. As shown in the drawing, the wind turbine 1 includes: a wind turbine rotor 6 having a plurality of wind turbine blades 2 and a hub 4 to which the plurality of wind turbine blades 2 is mounted; a nacelle 8; and a tower 10 for supporting the nacelle 8. In the wind turbine 1 shown in FIG. 1, three wind turbine blades 2 are mounted to the hub 4. In this wind turbine 1, when the wind is blowing against the wind turbine blades 2, the wind turbine rotor 6 including the wind turbine blades 2 and the hub 4 rotates around a rotation axis.

The wind turbine 1 may be a wind turbine generator. In this case, the nacelle 8 may house a generator and a power transmission mechanism for transmitting the rotation of the wind turbine rotor 6 to the generator. The wind turbine 1 may be configured such that rotation energy transmitted from the wind turbine rotor 6 to the generator through the power transmission mechanism is converted into electric energy.

The wind turbine 1 includes a strain sensor 20 which detects a strain of each of the wind turbine blades 2. In the wind turbine 1 shown in FIG. 1, the strain sensor 20 is disposed at a blade root part 12 of each of the wind turbine blades 2.

For instance, a FBG (Fiber Bragg Grating) sensor can be used as the strain sensor 20. The FBG sensor is an optical fiber sensor on which Bragg grating is inscribed, and the FBG sensor detects a variation in a grating gap caused by strain or thermal expansion based on a wavelength change of a reflected light.

Further, in the wind turbine 1 shown in FIG. 1, the blade root part 12 is a structural part which constitutes an end of the wind turbine blade 2 on a side of the hub 4. The blade root part 12 is formed in a cylindrical shape, and the blade root part 12 bears bending moment transmitted from the wind turbine blade 2 to the hub 4.

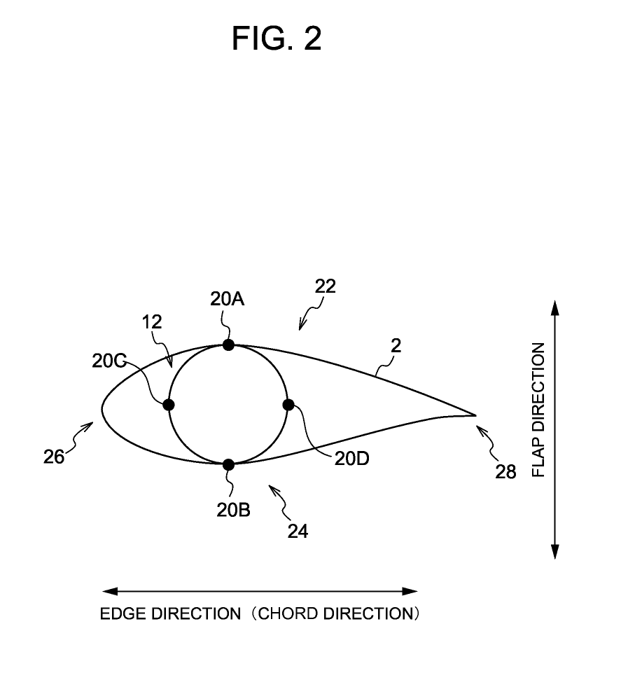

Herein, with reference to FIG. 2, an arrangement of the strain sensor 20 and the strain data acquired by the strain sensor 20 will be described as follows.

FIG. 2 is a sectional view orthogonal to the longitudinal direction of the wind turbine blade 2 in the blade root part 12 of the wind turbine blade 2 shown in FIG. 1.

In FIG. 2, an edge direction is a chord direction connecting a leading edge 26 and a trailing edge 28 in a section orthogonal to a longitudinal direction of the wind turbine blade 2, and a flap direction is a direction orthogonal to the chord direction in the same section.

As shown in FIGS. 1 and 2, a pair of strain sensors 20A, 20B and a pair of strain sensors 20C, 20D are attached to the blade root part 12 of the wind turbine blade 2. The strain sensors 20A, 20B are arranged along the flap direction to face each other across the wind turbine blade 2. The strain sensors 20C, 20D are arranged along the edge direction to face each other across the wind turbine blade 2. More specifically, in the blade root part 12 of the wind turbine blade 2, the strain sensors 20A to 20D are attached to the suction side 22, the pressure side 24, the leading edge 26 side, and the trailing edge 28 side, respectively. Based on measurement data by these strain sensors 20A to 20D, the strain data at a respective mounting position of each of the strain sensors 20A to 20D can be obtained.

The strain data indicates a value based on the strain detected by the strain sensor 20.

For instance, the strain ε_{F} in the flap direction of the wind turbine blade 2 can be acquired by calculating the difference of the strain obtained by the strain sensors 20A and 20B that are disposed on a suction side 22 and a pressure side 24 of the blade root part 12 of the wind turbine blade 2, respectively. The strain ε_{E} in the edge direction of the wind turbine blade 2 can be acquired by calculating the difference of the strain obtained by the strain sensors 20C and 20D that are disposed on a leading edge 26 and a trailing edge 28 of the blade root part 12 of the wind turbine blade 2, respectively. The strain ε_{F} in the flap direction or the strain ε_{E} in the edge direction can be used as the strain data.

When the damage occurs in the blade root part, the measured strain changes, and the strain data indicating the value based on the strain also changes. Therefore, in a case where the strain data changes, it can be judged that any damage in the blade root part has occurred.

Furthermore, the wind turbine 1 shown in FIG. 1 includes a damage detection part 30 for detecting the damage of the wind turbine blade 2. As will be later described, the damage detection part 30 can detect the damage of the wind turbine blade 2.

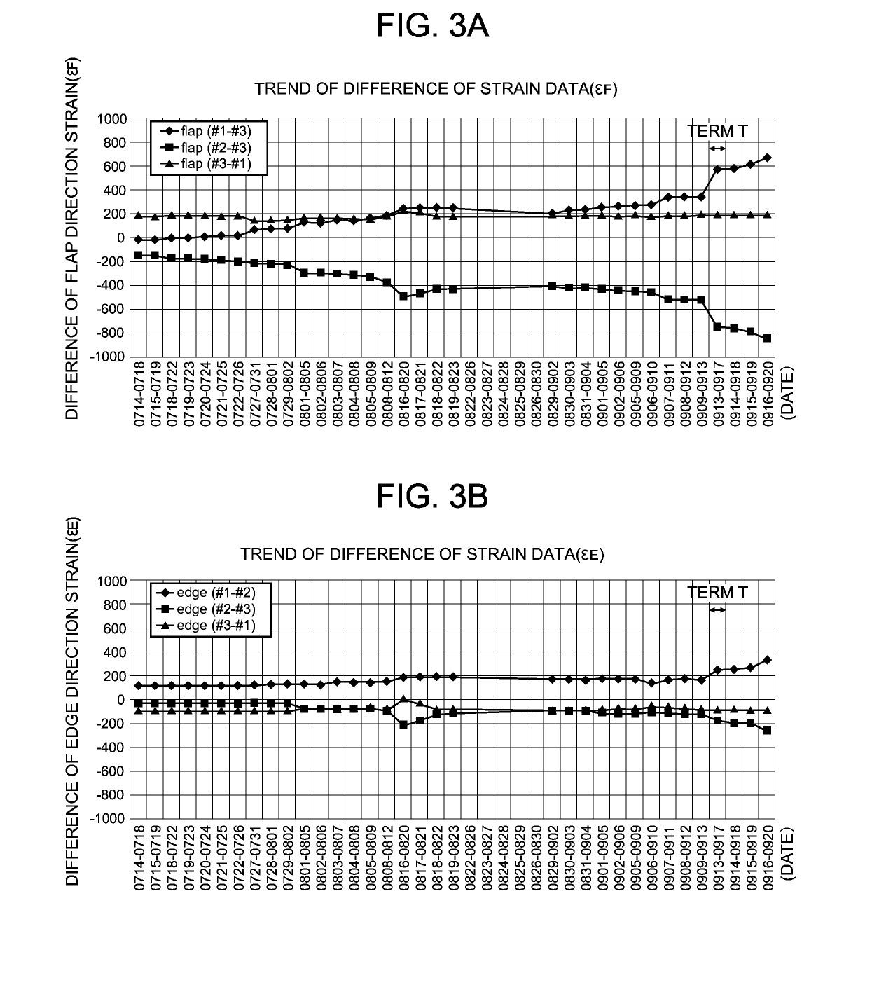

Hereafter, with reference to FIGS. 3 to 7, embodiments as to the method for detecting a damage of a wind turbine blade 2 in the wind turbine rotor 6 of the wind turbine 1 shown in FIG. 1 will be described. This method uses the strain data related to the flap direction and the edge direction which is acquired using the strain sensors 20 (20A to 20D). However, in the method for detecting the damage of the wind turbine blade according to the present invention, the mounting position of the strain sensor and the acquired strain data are not limited to those related to the flap direction or the edge direction, and the strain data related to a direction other than the flap direction and the edge direction may be used.

As will be later described, the method for detecting a damage of a wind turbine blade according to some embodiments includes a strain data acquiring step, a difference calculation step, and a detection step.

In the strain data acquiring step, the strain data representing the strain of each of the wind turbine blades 2 are acquired.

As mentioned above, for instance, the strain ε_{F} in the flap direction (hereinafter referred to as a flap direction strain) or the strain ε_{E} in the edge direction (hereinafter referred to as a edge direction strain) can be used as the strain data. The flap direction strain ε_{F} is a difference between the strains acquired by the strain sensors 20A, 20B attached to the suction side 22 and pressure side 24 of the blade root part 12 of the wind turbine blade 2. The edge direction strain ε_{E} is a difference between the strains acquired by the strain sensors 20C, 20D attached to the leading edge 26 side and trailing edge 28 side of the blade root part 12 of the wind turbine blade 2.

In the difference calculation step, a difference between the strain data of a detection target wind turbine blade which is one of the wind turbine blades 2 and a reference value reflecting the strain data of at least one comparison target wind turbine blade of other wind turbine blades 2 is calculated.

For instance, the strain data of one comparison target wind turbine blade of other wind turbine blades 2 can be used as the reference value. Further, the mean value of the strain data of at least two comparison target wind turbine blades of other wind turbine blades 2 can be used as the reference value. Also, the mean value of the strain data of at least two comparison target wind turbine blades and the strain data of one detection target wind turbine blade can be used as the reference value.

In the detection step, the damage of the detection target wind turbine blade is detected based on trend of the difference calculated in the difference calculation step.

Thus, the damage of the wind turbine blade 2 is detected by using the difference between the strain data of the detection target wind turbine blade which is one of the wind turbine blades 2 and the reference value reflecting the strain data of at least one comparison target wind turbine blade of other wind turbine blades 2. Thus, it is possible to eliminate the influence on the damage detection due to an operation state such as a change in wind speed or the like. Consequently, an abnormality due to the damage of the wind turbine blade 2 can be accurately detected.

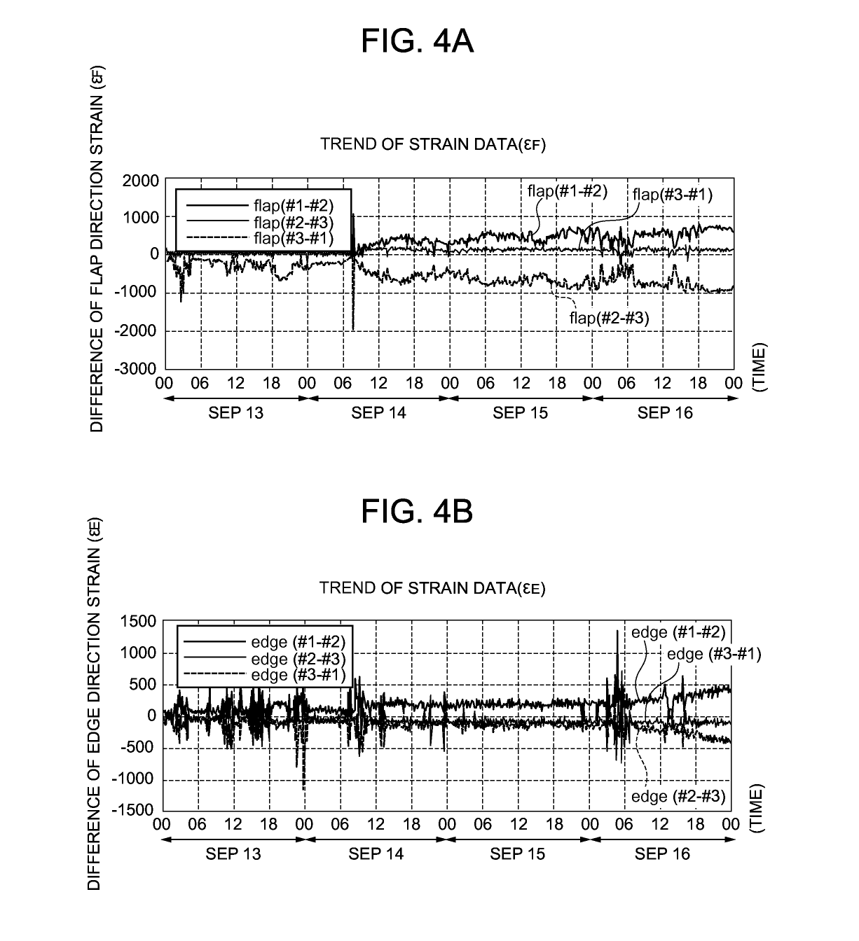

FIGS. 3 and 4 are graphs showing an example of the t trend of the difference of the strain data (the flap direction strain ε_{F} and the edge direction strain ε_{E}), in reference to FIG. 1. The strain data as to each of three wind turbine blades 2 are continuously acquired by the strain sensors 20, and differences of the strain data between any two of the wind turbine blades for every 10 minutes are calculated and plotted in FIGS. 3 and 4. Furthermore, the vertical axes of FIGS. 3 and 4 are represented as relative value (dimensionless quantity) to comprehend the trend of the difference in the flap direction strain or the edge direction strain, not as absolute quantity of the difference.

Hereinafter, in the specification, three wind turbine blades 2 are referred to as a wind turbine blade #1, a wind turbine blade #2, and a wind turbine blade #3, respectively. With respect to the difference between the strain data of each two of the wind turbine blades 2, for example, the difference between the flap direction strain (ε_{E}) of the wind turbine blade #1 and the flap direction strain (ε_{E}) of the wind turbine blade #2 is referred to as flap(#1-#2), and the difference between the edge direction strain (ε_{E}) of the wind turbine blade #1 and the edge direction strain (ε_{E}) of the wind turbine blade #2 is referred to as edge(#1-#2), or the like.

FIGS. 3A and 3B are graphs representing a long term trend regarding the change in the differences between mean values of each strain data of the wind turbine blades which are calculated from the strain data for every 10 minutes. FIG. 3A is a graph representing the differences of the strain data in the flap direction of the wind turbine blade 2. FIG. 3B is a graph representing the differences of the strain data in the edge direction of the wind turbine blade 2.

In FIGS. 3A and 3B, for instance, “0714-0718” in the horizontal axis represents an average of the mean values of the differences of the strain data acquired for every 10 minutes, during 5 days from July 14 to July 18. In the graphs of FIG. 3A and FIG. 3B, the breakage of the wind turbine blade #2 is occurred around September 20 being the end of the graph.

FIGS. 4A and 4B are graphs showing a short term trend about the change in the differences of the strain data. In these graphs, the differences of the mean values for every 10 minutes are plotted for a period when the differences of the strain data exhibits relatively rapid temporal change (i.e., the period T in FIGS. 3A and 3B).

According to one embodiment, in the detection step, when a value of the difference or a change rate of the difference exceeds a threshold value, the damage of the detection target wind turbine blade is detected.

As a result of intensive studies made by present inventors, it has been clear that the value of the difference or the change rate of the difference between the strain data of the detection target wind turbine blade and the reference value reflecting the strain data of the comparison target wind turbine blade rapidly increases immediately before the generation of the breakage of the wind turbine blade 2.

For instance, in FIGS. 3A and 3B, the values (absolute values) of flap(#1-#2) and edge(#1-#2) which are the differences between the strain data as to the wind turbine blade #1 and the strain data as to the wind turbine blade #2 increase with time (horizontal axis). And, in FIGS. 3A and 3B, the values (absolute values) of flap(#2-#3) and edge(#2-#3) which are the differences between the strain data as to the wind turbine blade #2 and the strain data as to the wind turbine blade #3 increase with time (horizontal axis). (Thus, it can be identified that the damaged wind turbine blade is the wind turbine blade #2 included as the common term. The identification of the damaged wind turbine blade will be described below.) Further, it is apparent that the change rates of flap(#1-#2) and edge(#1-#2) and the change rates of flap(#2-#3) and edge(#2-#3) rapidly increase for the period including a day that is a few days earlier than a day when the breakage of the wind turbine blade #2 occurs. For instance, especially in FIG. 4B, it is apparent that the difference of the strain data on September 16 is larger and also the change rate of the difference of the strain data is larger, when the difference of the strain data on September 16 is compared with the difference of the strain data on September 15. Therefore, it is possible to judge whether the damage has occurred in the detection target wind turbine blade or not, according to whether theses parameters (the value of the difference of the strain data or the change rate of the difference of the strain data) exceed thresholds.

The thresholds of the parameters (the value of the difference between the strain data or the change rate of the difference between the strain data) are set during operation of the wind turbine blade 2 in a sound state (a state in which the damage of the wind turbine blade 2 has not occurred). When the parameters exceed thresholds, it is judged that the abnormality occurs in the wind turbine blade 2.

When it is judged that the abnormality has occurred in the wind turbine blade 2, the operation of the wind turbine 1 may be stopped, or an alarm may be raised. Further, the operation of the wind turbine 1 may be stopped or an alarm may be raised in case the data exceeding the thresholds appear not at only one point in time but at a number of points in time.

Furthermore, as shown in FIG. 3, if the long term trend (for example, the average for the term such as per day or per week) of the temporal change (the value of the difference of the strain data or the change rate of the difference of the strain data) in the difference of the strain data is monitored, the trend of the temporal change can be grasped far in advance of breakage of the wind turbine blade, and the breakage of the wind turbine blade can be predicted. Further, as shown in FIGS. 4A and 4B, if the short term trend (for example, the transition of the average of every 10 minutes for last several days) is monitored, a significant change could appear immediately before the breakage of the wind turbine blade. Thus, only the long term trend or only the short term trend of the temporal change in the difference of the strain may be monitored so as to detect the damage of the wind turbine blade. Further, both of the long term trend and the short term trend of the temporal change in the difference of the strain may be monitored so as to detect the damage of the wind turbine blade more accurately.

According to some embodiments, the difference for each of the wind turbine blades 2 is calculated by repeating the difference calculation step for each of the wind turbine blades 2 as the detection target wind turbine blade, and in the detection step, a damaged wind turbine blade is identified based on the difference as to each of the wind turbine blades 2.

When the damage occurs in any of the wind turbine blades 2, the value of the difference or the change rate of the difference is affected by whether or not the wind turbine blade 2 subject to the damage is the detection target wind turbine blade.

More specifically, when the detection target wind turbine blade is the wind turbine blade 2 in which abnormality has not occurred, it can be considered that the temporal change in the strain data acquired in the wind turbine blade 2 is limited, because there is no change in the strain caused by damage (for example, cracks or the like). Thus, it is considered that the limited influence is exerted on the value or the change rate of the difference between the strain data of the detection target wind turbine blade and a reference value reflecting the strain data of at least one comparison target wind turbine blade of other wind turbine blades. On the other hand, when the detection target wind turbine blade is the damaged wind turbine blade 2, it is considered that the strain of the wind turbine blade 2 changes due to the generation of cracks or the like. Therefore, the trend of the acquired strain data appears. Thus, the influence is exerted on the value of the difference or the change rate of the difference between the strain data of the detection target wind turbine blade and the reference value reflecting the strain data of the at least one comparison target wind turbine blade of other wind turbine blades.

Therefore, the damaged wind turbine blade can be identified based on the value of the difference or the change rate of the difference as to each of the wind turbine blades 2 which is repeatedly calculated by regarding each of wind turbine blades 2 as the detection target wind turbine blade.

According to one embodiment, the wind turbine rotor 6 include n wind turbine blades 2 (n being an integer of 3 or more), when the detection target wind turbine blade is i-th (i being an integer of not less than 1 and not greater than n) wind turbine blade 2, the differences as to the wind turbine blades 2 from 1st to n-th are calculated by repeating the difference calculation step for each of (n−1) wind turbine blades 2 except i-th wind turbine blade as the comparison target wind turbine blade, and, in the detection step, a damaged wind turbine blade 2 is identified based on the difference as to each of the wind turbine blades 2.

However, for instance, in the difference calculation step, if there is no problem with the detection even when the detection target wind turbine blade and the comparison target wind turbine blade are changed with each other, duplicative process can be omitted. For instance, in case of n=3, when the calculation result of the difference in the case of the detection target wind turbine blade being the 1st wind turbine blade (i=1) and the comparison target wind turbine blade being the 3rd wind turbine blade is compared with the calculation result of the difference in the case of the detection target wind turbine blade being the 3rd wind turbine blade (i=3) and the comparison target wind turbine blade being the 1st wind turbine blade, it may be considered that these calculation results have the same value but have reverse signs. Thus, the difference calculation step for any one of these cases may be omitted.

In this case, when the damage occurs in any of the wind turbine blades 2, the influence on the value of the difference or the change rate of the difference caused by the damage occurrence in any of the wind turbine blades 2 changes depending on whether the damaged wind turbine blade is the detection target wind turbine blade or the comparison target wind turbine blade. Therefore, as mentioned above, the damaged wind turbine blade can be identified based on the value of the difference or the change rate of the difference obtained by regarding each of the wind turbine blades 2 as the detection target wind turbine blade.

According to one embodiment, the wind turbine rotor 6 include n wind turbine blades 2 (n being an integer of 3 or more), and when the detection target wind turbine blade is i-th (i being an integer of 1 or more and (n−1) or less) wind turbine blade 2, the differences as to the wind turbine blades 2 from 1st to (n−1)-th are calculated by repeating the difference calculation step for (i+1)-th wind turbine blade as the comparison target wind turbine blade. When the detection target wind turbine blade is n-th wind turbine blade 2, the difference as to the n-th wind turbine blades 2 is calculated by repeating the difference calculation step for the 1st wind turbine blade as the comparison target wind turbine blade. In the detection step, a damaged wind turbine blade 2 is identified based on the difference as to each of the wind turbine blades 2.

In this case, when the damage occurs in any of the wind turbine blades 2, the influence on the value of the difference or the change rate of the difference caused by the damage occurrence of any of the wind turbine blades 2 changes depending on whether the damaged wind turbine blade is the detection target wind turbine blade or the comparison target wind turbine blade. Therefore, as mentioned above, the damaged wind turbine blade can be identified based on the value of the difference or the change rate of the difference obtained by regarding each of the wind turbine blades 2 as the detection target wind turbine blade.

For instance, in FIG. 3A, the difference calculation step is repeated such that the detection target wind turbine blade is regarded as each of three of the wind turbine blade #1, the wind turbine blade #2, and the wind turbine blade #3 (n=3).

First of all, when the detection target wind turbine blade is the wind turbine blade #1 (i=1), the difference, referred to as “flap (#1-#2)”, between the strain data of the detection target wind turbine blade #1 and the strain data of the comparison target wind turbine blade #2 which is one of other wind turbine blades is calculated.

In the next, when the detection target wind turbine blade is the wind turbine blade #2 (i=2), the difference, referred to as “flap(#2-#3)”, between the strain data of the detection target wind turbine blade #2 and the strain data of the comparison target wind turbine blade #3 which is one of other wind turbine blades is calculated.

Finally, when the detection target wind turbine blade is the wind turbine blade #3 (i=3), the difference, referred to as “flap(#3-#1)”, between the strain data of the detection target wind turbine blade #3 and the strain data of the comparison target wind turbine blade #1 which is one of other wind turbine blades is calculated.

After repeating the difference calculation step in this way, in the detection step, the damaged wind turbine blade is identified based on each of the difference flap(#1-#2), flap(#2-#3) and flap(#3-#1) obtained in the difference calculation step.

In FIG. 3A, the value and the change rate of the difference flap (#3-#1) are smaller than the other value and change rate. Further, in regard to the differences flap(#1-#2) and flap(#2-#3), as shown in the graph, the signs of these values are opposite and the change rate also increases with the increase of the value (absolute value). This can lead to the conclusion that the damaged wind turbine blade is the blade #2 which affects the value and the change rate as to both of the difference flap(#1-#2) and the difference flap(#2-#3).

In this case, it may be judged that the damage has occurred in the wind turbine blades 2 (#1 to #3), when the differences of the strain data such as flap(#1-#2) exceed the thresholds which are set beforehand at a time when the wind turbine blade 2 (#1 to #3) is in a sound state (a state in which the damage has not occurred in the wind turbine blades 2 (#1 to #3)),

In this instance, the above thresholds may be set for each pair of the wind turbine blades 2 between which the difference of the strain data is to be acquired. More specifically, the threshold may be set as to each of the differences flap(#1-#2), flap(#2-#3) and flap(#3-#1), individually. This is because it is difficult to set a common threshold with respect to all pairs of the wind turbine blades due to individual differences of the wind turbine blades 2, individual differences of the strain sensors, and fine differences of the positions where the strain sensors are disposed.

Furthermore, although a case where the temporal change of the difference of the strain data in the flap direction shown in FIG. 3A is monitored is explained in the above embodiments, the same applies to a case where the temporal change of the difference of the strain data in the edge direction shown in FIG. 3B is monitored.

According to an embodiment, the at least one comparison target wind turbine blade in the difference calculation step is all of the other wind turbine blades 2 except the detection target wind turbine blade.

For instance, in three wind turbine blades 2 (the wind turbine blades #1 to #3), when the detection target wind turbine blade is the wind turbine blade #1, the at least one comparison target wind turbine blade is all of the other wind turbine blades 2 except the wind turbine blade #1 being the detection target wind turbine blade. More specifically, the comparison target wind turbine blades are the wind turbine blade #2 and the wind turbine blade #3. Similarly, when the detection target wind turbine blade is the wind turbine blade #2, the comparison target wind turbine blades are the wind turbine blade #1 and the wind turbine blade #3, and when the detection target wind turbine blade is the wind turbine blade #3, the comparison target wind turbine blades are the wind turbine blade #1 and the wind turbine blade #2.

In this case, the mean value of the strain data as to all wind turbine blades being the comparison target wind turbine blades may be used as “a reference value reflecting the strain data of the comparison target wind turbine blade”.

For instance, when the detection target wind turbine blade is the wind turbine blade #1, the reference value is an average of the strain data as to the wind turbine blade #2 and the wind turbine blade #3.

Thus, in this case, in the calculation step, the difference between the strain data as to the detection target wind turbine blade #1 and the average of the strain data as to the comparison target wind turbine blade #2 and the comparison target wind turbine blade #3 is calculated. Then, in the detection step, the damage of the detection target wind turbine blade #1 is detected based on the temporal change of the difference.

In this embodiment, when at least one of the wind turbine blades 2 is damaged, the value of the difference or the change rate of the difference is affected to some extent, whichever wind turbine blade 2 is the detection target wind turbine blade. However, the influence on the value of the difference or the change rate of the difference caused by the damage occurrence of any of the wind turbine blades 2 changes depending on whether the damaged wind turbine blade is the detection target wind turbine blade or the comparison target wind turbine blade.

More specifically, if the wind turbine blade #1 is damaged, when the wind turbine blade #1 is the detection target wind turbine blade, the calculation results of the difference or the change rate of the difference will be affected relatively significantly because the strain data of the wind turbine blade #1 itself is used to calculate the difference in the calculation step.

On the other hand, when the wind turbine blade #1 is the comparison target wind turbine blade, the extent to which the calculation results of the difference or the change rate of the difference will be affected is relatively small compared to a case where the wind turbine blade #1 is the detection target wind turbine blade because the average value of the strain data of the wind turbine blade #1 and any of the other wind turbine blades is used to calculate the difference.

In this way, the influence of the value of the difference or the change rate of the difference varies depending on whether or not the damaged wind turbine blade is the detection target wind turbine blade or the comparison target wind turbine blade.

Thus, if a wind turbine blade is identified as the one affecting the value of the difference or the change rate of the difference, it can be judged that the damage has occurred in that wind turbine blade.

Furthermore, when the wind turbine rotor 6 includes at least three wind turbine blades 2, the damaged wind turbine blade can be identified in the above described manner.

On the other hand, when the wind turbine rotor 6 includes only two wind turbine blades 2, the damaged wind turbine blade cannot be identified based on the change rate of the difference, because a pair of the differences which is calculated have the same value and reverse signs, for example flap(#1-#2) and flap(#2-#1) or the like, and the values of the change rates is same (however, these signs are opposite). However, the damage of the wind turbine blade can be detected based on a trend of the difference (increase or decrease, etc.).

In some embodiments, a method for detecting a damage of a wind turbine blades 2 includes a time mean calculation step of calculating a mean value of the strain data acquired in the strain data acquiring step for a longer period than a rotation period of the wind turbine rotor. Then, in the detection step, the damage of the detection target wind turbine blade is detected based on the mean value calculated in the time mean calculation step.

When an azimuth angle of the wind turbine blade 2 changes with a rotation of the wind turbine rotor 6, an altitude of the wind turbine blade 2 is also changed. Furthermore, wind speed is generally higher as the altitude is higher. Thus, during an operation of the wind turbine 1, a load acting on the wind turbine blade 2 changes periodically depending on wind speed, and the strain generated in the wind turbine blade 2 also changes periodically.

According to the embodiment, the damage of the detection target wind turbine blade is detected based on the mean value of the strain data acquired for the longer period than a rotation period of the wind turbine rotor 6. Thus, it becomes possible to exclude influences of the periodic change of the strain of the wind turbine blade 2 to evaluate the damage, whereby the damage of the wind turbine blade 2 can be more accurately detected.

When the rotation period of the wind turbine rotor 6 is several seconds to several tens seconds, the damage of the detection target wind turbine blade may be detected based on average of the strain data for a period (e.g., 10 minutes) which is sufficiently longer than the rotation period.

Furthermore, the azimuth angle is the angle formed between a prescribed reference line and an axis line of the wind turbine blade 2 in the rotational plane of the wind turbine blades 2. In an embodiment, when the wind turbine blade 2 is positioned on a top of the wind turbine 1, the prescribed reference line conforms with the axis line of the wind turbine blade 2. In this case, the azimuth angle is 0 degree when the wind turbine blade 2 is positioned at a top of the wind turbine 1, the azimuth angle is 180 degree when the wind turbine blade 2 is positioned at a bottom of the wind turbine 1.

According to some embodiments, in the detection step, the damage of the detection target wind turbine blade is detected by using only at least part of the strain data acquired in the strain acquiring step, the at least part of the strain data being acquired when wind speed is within a specified wind speed range.

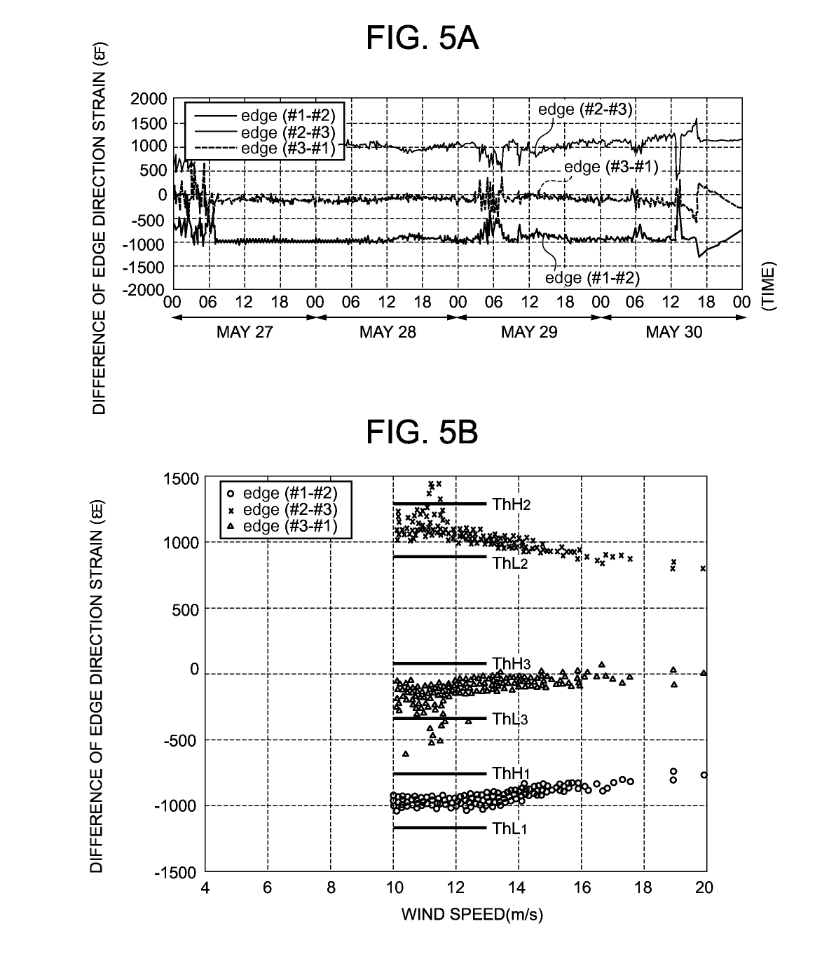

FIG. 5A is a graph showing trend of the difference of the strain data (the difference of the edge direction strain (ε_{E})) acquired for the wind turbine blades #1 to #3 of the wind turbine 1 shown in FIG. 1. FIG. 5B is a graph obtained by plotting the difference of the strain data shown in FIG. 5A relative to wind speed (horizontal axis). Furthermore, it is different between the strain data shown in FIGS. 5A and 5B and the strain data shown in FIGS. 3 and 4 when and where the strain data were acquired. The vertical axes of FIGS. 5A and 5B are represented as relative value (dimensionless quantity) to comprehend the trend of the difference of the flap direction strain or the edge direction strain, not as absolute quantity of the difference.

Since the load acting on the wind turbine blade 2 depends on wind speed, the strain data acquired in the strain data acquiring step varies with wind speed at a time when the strain data is acquired.

For instance, as shown in FIG. 5B, the difference (edge(#1-#2) and others) of the edge direction strain (ε_{E}) tends to increase or decrease as wind speed becomes higher.

In this case, the damage of the detection target wind turbine blade is detected by using only the strain data acquired when wind speed is in a specified wind speed range that is 10 to 13 m/s. As a result, the influence caused by variance of the strain data due to a change in the wind speed can be reduced, whereby the damage of the wind turbine blade 2 can be more accurately detected.

Furthermore, in FIG. 5B, Th_{H1}, Thu_{L1}, Th_{H2}, Thu_{L2}, Th_{H3}, and Th_{L3} represent the previously set thresholds in regard to the values of edge(#1-2), edge(#2-3) and edge(#3-1) each of which are the difference of the edge direction strain (ε_{E}).

With reference to FIG. 5B, within a specified wind speed range which is 10 to 13 m/s, the differences beyond the threshold are edge(#2-3) and edge(#3-1), that is, a pair of the wind turbine blade #2 and the wind turbine blade #3, and a pair of the wind turbine blade #3 and the wind turbine blade #1. Thus, it can be identified that the damaged wind turbine blade is the wind turbine blade #3 which is included in both of these two pair.

According to some embodiments, in the strain data acquiring step, the strain data is acquired for both of a suction side 22 and a pressure side 24 of each wind turbine blade 2 by using a pair of strain sensors 20A, 20B provided for each of the blade root parts 12 on the suction side 22 and the pressure side 24. Then, in the detection step, the damage of the wind turbine blade 2 is detected based on the difference between the strain data of the suction side 22 and the strain data of the pressure side 24 acquired for each wind turbine blade 2.

The change in the strain of the wind turbine blade 2 tends to appear remarkably in a flap direction than in an edge direction. This is because the load is likely to act on the wind turbine blade 2 in the flap direction than in the edge direction, as the pressure side 24 of the wind turbine blade 2 faces front (i.e., the windward side) to receive the wind and static pressure always acts on the suction side 22 of the wind turbine blade 2.

Thus, the damage of the wind turbine blade 2 can be determined easily in the detection of the damage of the wind turbine blade because the damage of the wind turbine blade 2 is detected based on the difference between the strain data of a suction side 22 and the strain data of a pressure side 24 of the wind turbine blade 2, namely the strain associated with the flap direction.

According to another embodiment, a method for detecting a damage of a wind turbine blade 2 includes a strain data acquiring step, a coefficient calculation step, and a detection step.

In the strain data acquiring step, a strain data representing a strain of each of the at least one wind turbine blade 2 is acquired by using a strain sensor 20 provided on a blade root part 12 of each of the at least one wind turbine blade 2.

In the coefficient calculation step, a coefficient is calculated which is representing a relationship between the strain data acquired in the strain data acquiring step and a blade root moment acting on the blade root part 12 of the wind turbine blade 2.

In the detection step, when a trend of the coefficient calculated in the coefficient calculation step deviates from a specified range, the damage of the wind turbine blade 2 is detected.

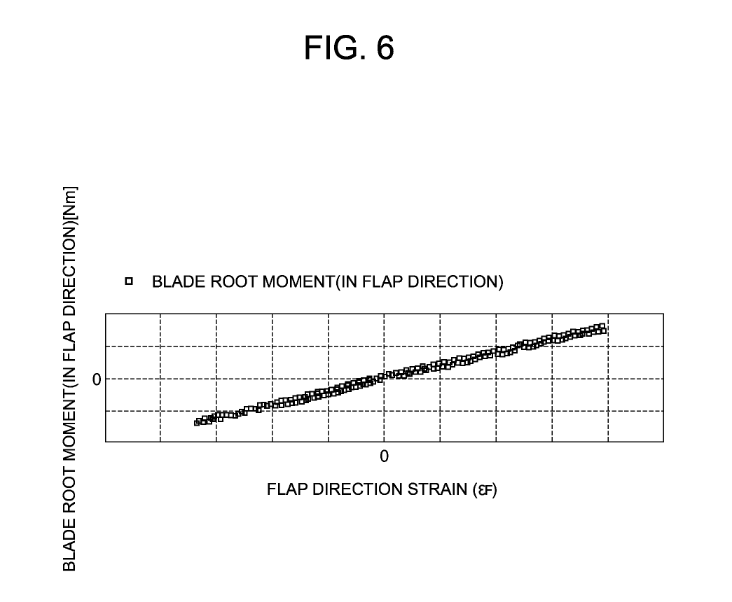

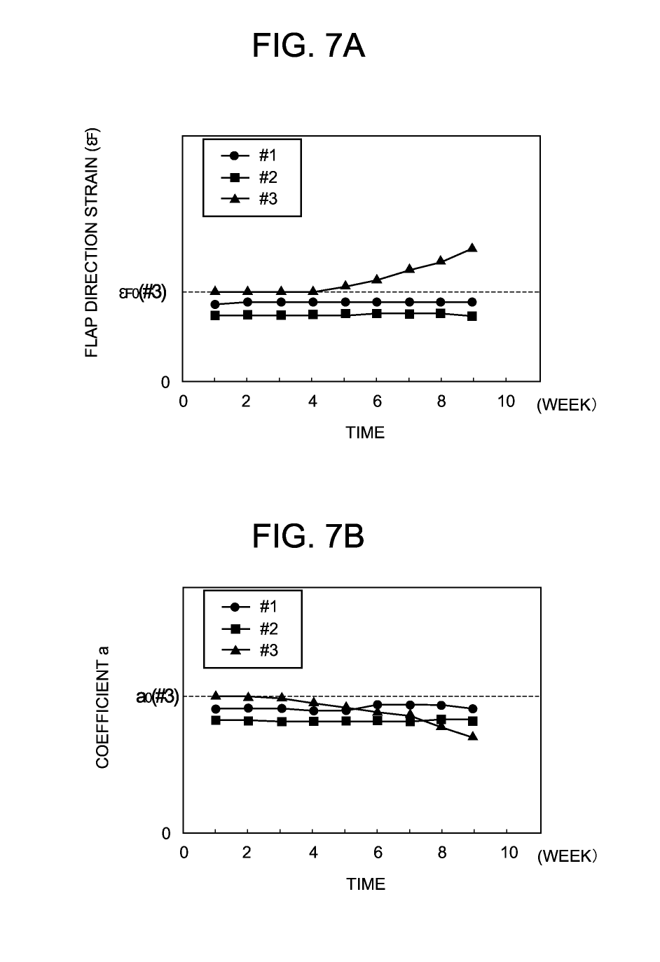

With reference to FIGS. 6 and 7, a case where the above embodiment is applied to the wind turbine rotor 6 including three wind turbine blades 2 will be explained. FIG. 6 is a graph showing an example of the relation between the strain data and the blade root moment of the wind turbine blade shown in FIG. 1. FIG. 7A is a graph showing an example of the trend of a flap direction strain (ε_{F}) of the wind turbine blade (#1 to #3). FIG. 7B is a graph showing an example of the change of the coefficient in a case where the flap direction strain (ε_{F}) of the wind turbine blade is changed.

Although the following description relates to the strain data, the root moment, and the coefficient representing a relationship between the strain data and the root moment in the flap direction, the same applies to the edge direction.

In the strain data acquiring step, a strain data representing a strain of each of the wind turbine blades 2 is acquired.

The flap direction strain ε_{F} is acquired as the strain data. The flap direction strain is the difference of the strain obtained by the strain sensors 20A and 20B respectively provided on the suction side 22 and the pressure side 24 of the blade root part 12 of the wind turbine blade 2. Furthermore, the edge direction strain ε_{E} may be acquired as the strain data. The edge direction strain is the difference of the strain obtained by the strain sensors 20C and 20D respectively provided on the leading edge 26 side and the trailing edge 28 side of the blade root part 12 of the wind turbine blade 2.

In the coefficient calculation step, a coefficient representing a relationship between the flap direction strain ε_{F} being the strain data acquired in the strain data acquiring step and a blade root moment acting on the blade root part 12 of the wind turbine blade 2 in the flap direction is calculated.

The graph shown in FIG. 6 represents a relationship between the blade root moment M_{F} in the flap direction and the flap direction strain ε_{F}. The relationship is liner, and it is approximated with the primary expression, M_{F}=a×ε_{F}+b. Thus, the coefficient a is calculated by using the primary expression. Furthermore, the coefficient a in the primary expression is the coefficient representing a relationship between the blade root moment M_{F} in the flap direction and the flap direction strain ε_{F}, and represents the inclination of the graph shown in FIG. 6.

Herein, a₀ is the coefficient a in a case where the wind turbine blade 2 is in a sound state. Furthermore, ε_{F 0} is the flap direction strain in a case where the coefficient a is a₀.

When the strain of any of the wind turbine blades (#1 to #3) changes due to the crack or the like, the strain data such as the flap direction also changes in that wind turbine blade. For instance, when cracks occur in the wind turbine blade #3 which is one of the three wind turbine blades #1 to #3 included in the wind turbine rotor 6, the strain of the wind turbine blade #3 changes due to the occurrence and the progress of cracks or the like, and the strain data acquired by the strain sensor 20 changes as well. For instance, as shown in FIG. 7A, whereas the flap direction strain ε_{F} has not significantly changed regarding the wind turbine blades #1 and #2 which are in a sound state and not damaged, the flap direction strain ε_{F} for the wind turbine blade #3 in which the crack has occurred increases with time from the value ε_{F 0} (#3) in the sound state.

By the way, the weight of the wind turbine blade 2 is constant regardless of the change in the strain (for example, the change in the strain caused by the occurrence of cracks or the like), and thus the blade root moment acting on the blade root is also constant regardless of the influence of the value of the strain. That is, as shown in FIG. 7B, the coefficient a for the wind turbine blade #3 decreases from the value a₀ (#3) in the sound state with increase of the flap direction strain ε_{F} that is shown in FIG. 7A, because the blade root moment represented by MF=a×ε_{F}+b is constant.

Furthermore, with respect to the wind turbine blade #1 and the wind turbine blade #2, since there are no significant changes in the flap direction strain ε_{F} shown in FIG. 7A, the coefficient a does not significantly change in each of these wind turbine blades as shown in FIG. 7B.

Therefore, based on the temporal change of the coefficient (herein, “a” of MF=a×ε_{F}+b) representing the relationship between the strain data (herein, the flap direction strain ε_{F}) acquired by the strain sensor 20 and the blade root moment (herein, the moment in the flap direction) acting on the blade root part 12 of the wind turbine blade 2, the damage of the wind turbine blade 2 can be detected. That is, the damage of the wind turbine blade #3 can be detected by monitoring the temporal change of the coefficient “a”.

In order to detect the damage of the wind turbine blade 2 in the detection step, a threshold is set for the coefficient “a”. When the coefficient “a” deviates from a range specified by the threshold, it is judged that the damage has occurred in the wind turbine blade 2.

For instance, the coefficient a₀ in the sound state is used as a reference value, and it may be judged that the damage has occurred in the wind turbine blade 2 when the coefficient a changes by 10% or more (increase or decrease) relative to the coefficient a₀.

The thresholds and the specified ranges may be set for each of the wind turbine blades 2. In each of the wind turbine blades 2, the thresholds and the specified ranges may be set for each direction (for example, the flap direction or the edge direction).

This is because it is difficult to set a common threshold for a number of wind turbine blades due to individual differences of the wind turbine blades 2, individual differences of the strain sensors 20, and fine differences of the positions where the strain sensors 20 are disposed.

In the method according to the above embodiments, since the damage of the wind turbine blade itself is detected based on the strain data for each of the wind turbine blades, the method can be applicable to the wind turbine rotor 6 including one wind turbine blade or a plurality of wind turbine blades.

In the wind turbine 1 shown in FIG. 1, the damage of the wind turbine blade 2 may be detected by a damage detection part 30.

The damage detection part 30 is configured to calculate the difference between the strain data of the detection target wind turbine blade which is one of the wind turbine blades 2 and the reference value reflecting the strain data of at least one comparison target wind turbine blade of other wind turbine blades, for the strain data of each of the wind turbine blades 2 acquired based on the detection result by the strain sensor 20. The damage detection part 30 is configured to detect the damage of the wind turbine blade 2 based on the trend of the difference.

The strain data may be the flap direction strain ε_{F} or the edge direction strain ε_{E} described above.

Further, the difference between the strain data of the detection target wind turbine blade which is one of the wind turbine blades 2 and the reference value reflecting the strain data of at least one comparison target wind turbine blade of other wind turbine blades may be the difference between the strain data of one detection target wind turbine blade and the strain data of the comparison target wind turbine blade which is one wind turbine blade of other wind turbine blades (for example, flap(#1-#2) or edge(#1-#2) as described above), or may be the difference between the strain data of one detection target wind turbine blade and the mean value of the strain data of all comparison target wind turbine blades.

The predetermined thresholds as to the difference are stored in the damage detection part 30. The damage detection part 30 may be configured to compare the difference acquired based on the detection result by the strain sensor 20 with the stored threshold, and to detect the damage of the detection target wind turbine blade when the difference exceeds the threshold.

Furthermore, the anemometer may be provided on the wind turbine 1 to input data measured by the anemometer into the damage detection part 30.

### REFERENCE SIGNS LIST

1 Wind turbine
2 Wind turbine blade
4 Hub
6 Wind turbine rotor
8 Nacelle
10 Tower
12 Blade root part
20 Strain sensor
22 Suction side
24 Pressure side
26 Leading edge
28 Trailing edge
30 Damage detection part

1. A method for detecting a damage of a wind turbine blade of a wind turbine rotor including a plurality of wind turbine blades, the method comprising:
a strain data acquiring step of acquiring strain data representing strain of each of the plurality of wind turbine blades;
a difference calculation step of calculating a difference between the strain data of a detection target wind turbine blade which is one of the wind turbine blades and a reference value reflecting the strain data of at least one comparison target wind turbine blade of other wind turbine blades; and
a detection step of detecting the damage of the detection target wind turbine blade based on a trend of the difference calculated in the difference calculation step.

2. The method for detecting the damage of the wind turbine blade according to claim 1,
wherein, in the detection step, when a value of the difference or a change rate of the difference exceeds a threshold value, the damage of the detection target wind turbine blade is detected.

3. The method for detecting the damage of the wind turbine blade according to claim 1,
wherein the wind turbine rotor includes at least three wind turbine blades,
wherein the difference of each of the wind turbine blades is calculated by repeating the difference calculation step for each of the wind turbine blades as the detection target wind turbine blade, and
wherein, in the detection step, a damaged wind turbine blade is identified based on the difference as to each of the wind turbine blades.

4. The method for detecting the damage of the wind turbine blade according to claim 3,
wherein the at least one comparison target wind turbine blade is all of the other wind turbine blades except the detection target wind turbine blade.

5. The method for detecting the damage of the wind turbine blade according to claim 3,
wherein the wind turbine rotor include n wind turbine blades, n being an integer of 3 or more,
wherein, when the detection target wind turbine blade is i-th wind turbine blade, the differences as to the wind turbine blades from 1st to n-th are calculated by repeating the difference calculation step for each of (n−1) wind turbine blades except i-th wind turbine blade as the comparison target wind turbine blade, i being an integer of not less than 1 and not greater than n,
wherein, in the detection step, a damaged wind turbine blade is identified based on the difference as to each of the wind turbine blades.

6. The method for detecting the damage of the wind turbine blade according to claim 1, further comprising:
a time mean calculation step of calculating a mean value of the strain data acquired in the strain data acquiring step for a longer period than a rotation period of the wind turbine rotor,
wherein, in the detection step, the damage of the detection target wind turbine blade is detected based on the mean value calculated in the time mean calculation step.

7. The method for detecting the damage of the wind turbine blade according to claim 1,
wherein, in the detection step, the damage of the detection target wind turbine blade is detected by using only at least part of the strain data acquired in the strain acquiring step, the at least part of the strain data being acquired when wind speed is within a specified wind speed range.

8. A method for detecting a damage of a wind turbine blade of a wind turbine rotor including at least one wind turbine blade, the method comprising:
a strain data acquiring step of acquiring strain data representing a strain of each of the at least one wind turbine blade by using a strain sensor provided on a blade root of each of the at least one wind turbine blade;
a coefficient calculation step of calculating a coefficient representing a relationship between the strain data acquired in the strain data acquiring step and a blade root moment acting on the blade root of the wind turbine blade; and
a detection step of detecting the damage of the wind turbine blade when a trend of the coefficient calculated in the coefficient calculation step deviates from a specified range.

9. The method for detecting the damage of the wind turbine blade according to claim 1,
wherein, in the strain data acquiring step, the strain data is acquired for both of a suction side and a pressure side of each wind turbine blade by using a pair of strain sensors provided for each of the blade roots on the suction side and the pressure side of each of the blade roots,
wherein, in the detection step, the damage of the wind turbine blade is detected based on the difference between the strain data of the suction side and the strain data of the pressure side acquired for each wind turbine blade.

10. The method for detecting the damage of the wind turbine blade according to claim 8,
wherein, in the strain data acquiring step, the strain data is acquired for both of a suction side and a pressure side of each wind turbine blade by using a pair of strain sensors provided for each of the blade roots on the suction side and the pressure side of each of the blade roots,
wherein, in the detection step, the damage of the wind turbine blade is detected based on the difference between the strain data of the suction side and the strain data of the pressure side acquired for each wind turbine blade.

11. A wind turbine comprising;
a wind turbine rotor including wind turbine blades;
a strain sensor for detecting strain of each of the wind turbine blades; and
a damage detection part for detecting a damage of the wind turbine blades,
wherein the damage detection part is configured to calculate a difference between the strain data of a detection target wind turbine blade which is one of the wind turbine blades and a reference value reflecting the strain data of at least one comparison target wind turbine blade of other wind turbine blades so as to detect the damage of the wind turbine blade based on a trend of the difference.
